(19) United States
(12) Patent Application Publication
(10) Pub. No.: US 2011/0156398 A1
(43) Pub. Date: Jun. 30, 2011

(54) APPARATUS FOR GENERATING POWER FROM A FLUID STREAM

(76) Inventor: Marc Paish, Hull (GB)

(21) Appl. No.: 13/057,410

(22) PCT Filed: Aug. 4, 2009
(86) PCT No.: PCT/GB2009/001924

§ 371 Date: Mar. 17, 2011

(30) Foreign Application Priority Data
Aug. 5, 2008 (GB) 0814257.2

(51) Int. Cl. F03B 17/00

(52) U.S. Cl. 290/54

(57) ABSTRACT

An apparatus for generating power from a fluid stream flowing along a stream bed, includes a base. The base includes a lower face for resting on the stream bed. A foil arm is pivotally connected to the base. A foil is pivotally connected to the foil arm remote from the base. The base further includes an upper face for directing fluid flow towards the foil to augment fluid flow over the foil.

The present invention relates to an apparatus for generating power from a fluid stream. More particularly, but not exclusively, the present invention relates to an apparatus comprising a base and first and second foil arms pivotally connected to the base at spaced apart points, the foils inwardly extending towards each other, the base having an upper surface for directing and augmenting fluid flow over the foils.

It is known to generate power from a fluid stream by means of a foil arm pivotally connected to a frame at a pivot point. A foil is pivotally connected to the foil arm remote from the pivot point. An angle change assembly is typically connected between the foil and the foil arm for changing the angle of the foil with respect to the flow of the fluid stream.

In use, the foil arm is arranged with the foil in the fluid stream. The angle change assembly orients the foil with respect to the stream to cause the foil arm to pivot about the pivot point. When the foil arm reaches the end of its range of motion the angle change assembly reverses the orientation of the foil causing the foil arm to pivot in the opposite direction about the pivot point. This is repeated causing the foil arm to oscillate back and forth in the fluid stream. Mechanical or hydraulic linkage transfers this movement to a generator which converts this oscillating motion into electricity.

Such a known apparatus has a number of drawbacks. The speed of fluid flow through the system is the ambient speed of flow of the fluid. In addition, there is little control of the angle of incidence of the fluid on the foils. Further, if the flow is turbulent, or waves are particularly high the foils may be subject to very large forces when high ambient velocities combine with particularly unfavourable angles of incidence.

Accordingly, the present invention provides an apparatus for generating power from a fluid stream flowing along a stream bed, comprising
a base, the base comprising a lower face for resting on the stream bed;
a foil arm pivotally connected to the base; and,
a foil pivotally connected to the foil arm remote from the base;
the base further comprising an upper face for directing fluid flow towards the foil, so augmenting fluid flow over the foil.

The upper face directs the flow towards the foil. The speed of fluid flow through the operating area of the foils may therefore be larger than the average flow speed of the fluid allowing more power to be generated from the fluid flow. In addition, when the foil approaches the upper face, the upper face controls the angle of incidence of the fluid on the foils, allowing the foil and its control to be optimised. As a further advantage, the fluid flow close to the upper face is substantially parallel to upper face for a wide range of incident fluid angles. If the flow is especially fast or turbulent the foil can be stored close to the upper face with certainty that large fluid velocities perpendicular to the face are not possible.

Preferably at least a portion of the upper face is convex.

At least a portion of the convex upper face can be curved.

Preferably, the convex upper face comprises a plurality of planar faces, each planar face inclined to an adjacent planar face.

Preferably, the convex upper face comprises first and second planar faces extending from the base face and inclined thereto and a third planar face extending therebetween.

Preferably, the third planar face is parallel to the base.

Preferably, the base is symmetric about a plane normal to the lower face.

The base can comprise at least one ballast tank.

Preferably, the apparatus further comprises a pump for emptying and filling the ballast tank, preferably with air, to alter the buoyancy of the apparatus.

Preferably, the apparatus comprises at least one column adapted to be connected to the bed of the stream, the base being connected to the column.

The base can be adapted to be displaced along the column to alter the depth of the base in the stream.

The apparatus can further comprise a generator within the base for converting the pivoting motion of the foil arm into electricity.

Preferably, the apparatus comprises a plurality of foil arms pivotally connected to the base, each foil arm being pivotally connected to a foil.

Preferably, the apparatus comprises first and second foil arms pivotally connected to the base and extending towards each other,
each foil arm having a foil pivotally connected thereto;
the two foils being arranged side by side such that the upper face directs the fluid over both foils.

Preferably, the two foil arms connected to the foils extend away from the foils in substantially opposite directions.

The present invention will now be described by way of example only, and not in any limitative sense, with reference to the accompanying drawings in which

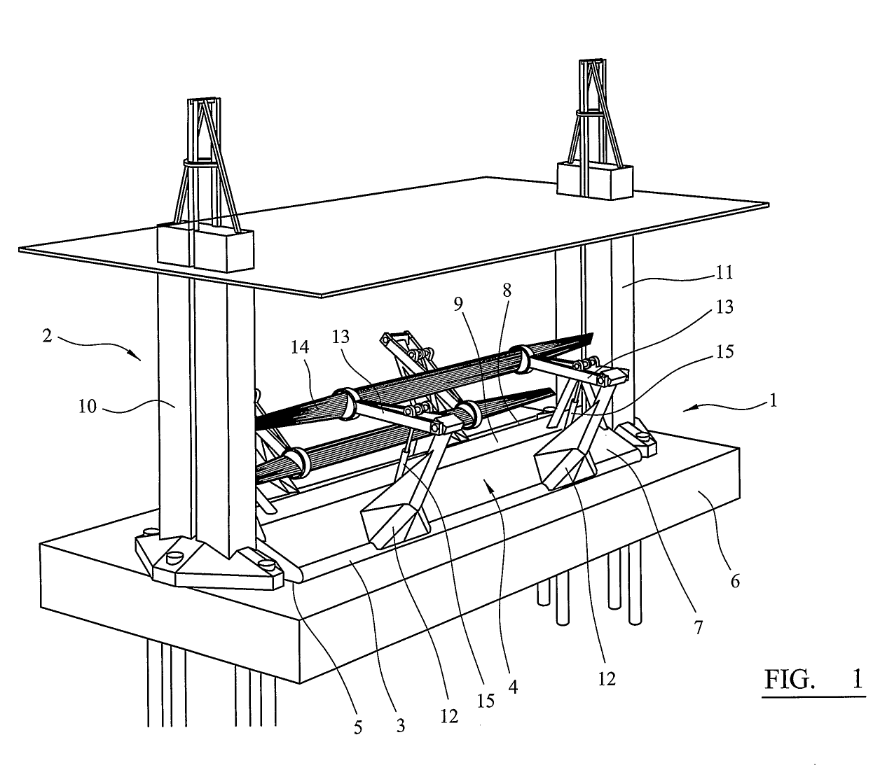

FIG. 1 shows an apparatus according to the invention in perspective view;

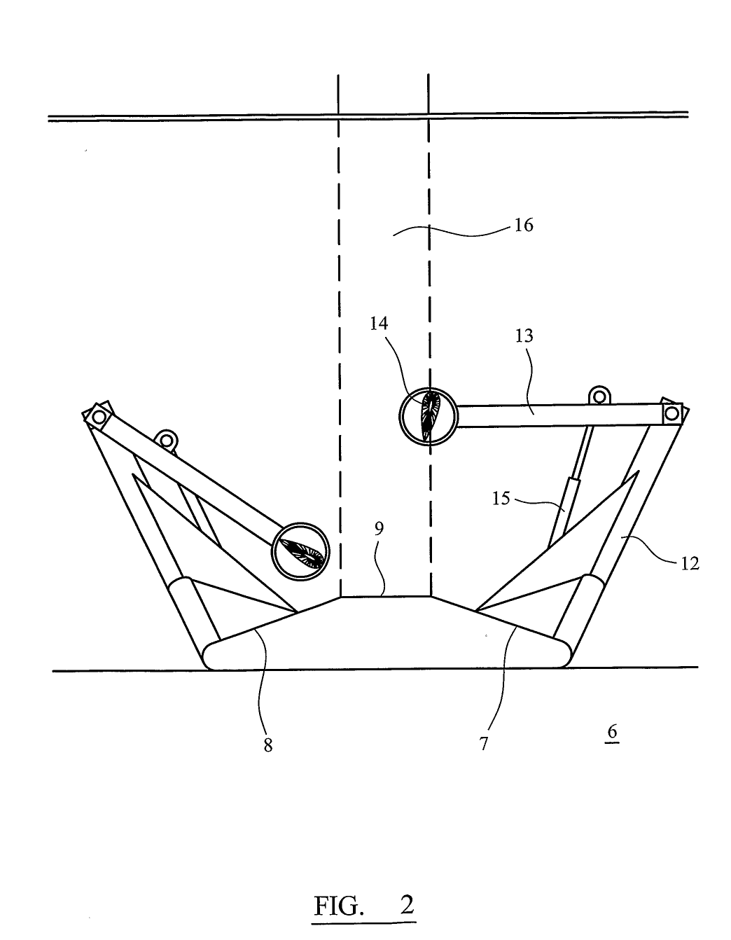

FIG. 2 shows the apparatus of FIG. 1 in cross section in operation;

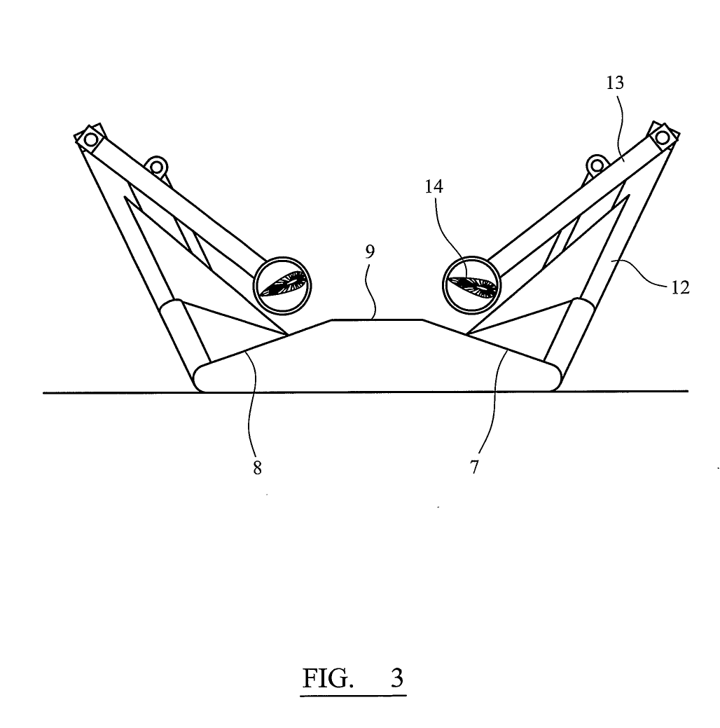

FIG. 3 shows the apparatus of FIGS. 1 and 2 in a storage position;

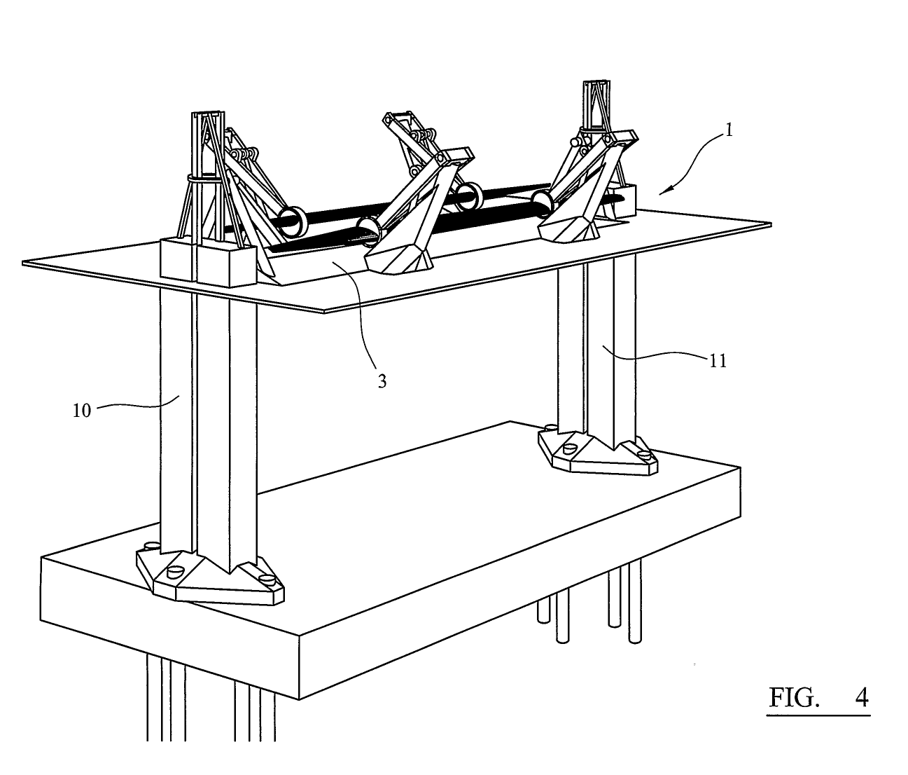

FIG. 4 shows the apparatus of FIGS. 1 to 3 with the base raised from the bed; and,

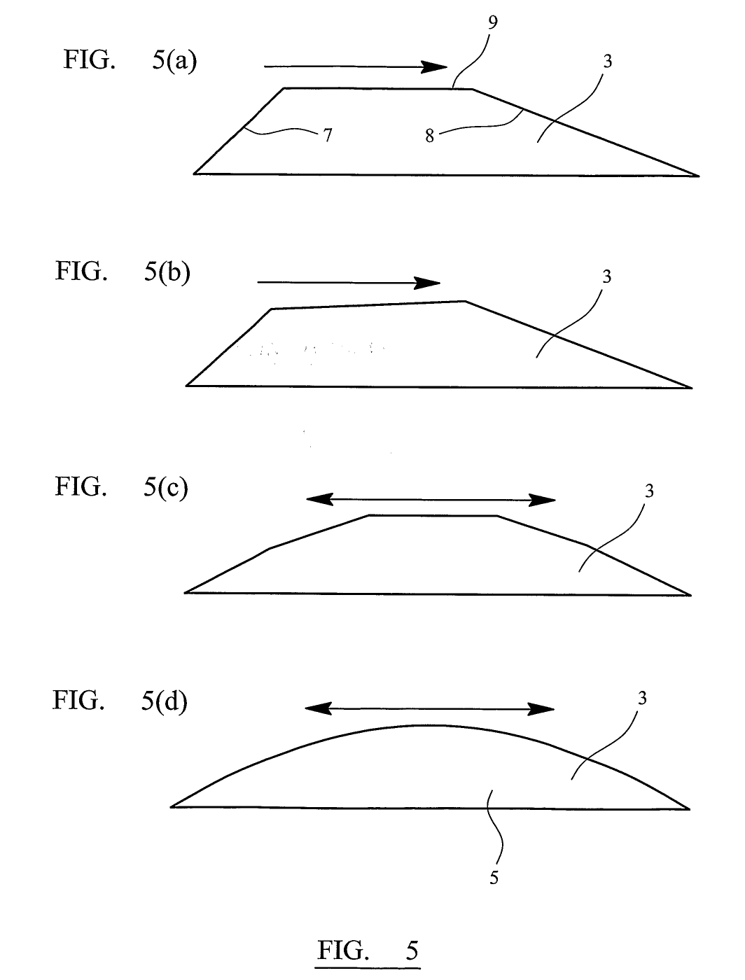

FIGS. 5(a) to 5(d) show a range of base cross sections of apparatus according to the invention.

Shown in FIG. 1 is an apparatus 1 according to the invention in perspective view arranged in a fluid stream 2. The apparatus 1 comprises a base 3 having upper and lower faces 4,5. The lower face 5 is arranged on the stream bed 6.

The upper face 4 is convex and comprises a plurality of planar faces 7-9. In this embodiment the upper face 4 comprises first and second planar faces 7,8 both of which extend from spaced apart points on the lower face 4. The first and second faces 7,8 both extend from the lower face 5 at an acute angle towards each other as shown. Extending between the first and second planar faces 7,8 is a third planar face 9. The third planar face 9 is substantially parallel to the lower face 5 as shown. The space between the upper and lower faces defines a base volume.

Contained within the base volume is a plurality of ballast tanks (not shown). Each ballast tank is connected to means (not shown) for filling and emptying the ballast tank, preferably with the air, to adjust the buoyancy of the base 3 as required.

The base 3 is arranged between first and second columns 10,11 each column 10,11 being connected to the stream bed 6 as shown. The base 6 and columns 10,11 are arranged such that the base 3 can be raised up and down between the columns 10,11 if required to raise the base 3 in the stream 2.

The base 3 further comprises a plurality of support arms 12. In this embodiment the support arms 12 extend from the first and second planar faces 7,8 of the base 3. Pivotally connected to each of the support arms 12 is a foil arm 13. The end of each foil arm 13 remote from its support arm 12 is pivotally connected to a foil 14. A plurality of foil arms 13 is connected to each foil 14 to support the foil 14 across its width.

Connected between each foil 14 and the associated foil arm 13 is an angle change assembly (not shown). The angle change assembly varies the angle between the foils 14 and the associated foil arms 13. Also contained within the base 3 is a generator (not shown). The generator converts the pivotal motion of the foil arms 13 into electricity. A linkage means 15 which in this embodiment comprises hydraulic cylinders one below each foil arm 13, transfer the energy from the foils 14 into a hydraulic system (not shown) and which is coupled to the generator.

FIG. 2 shows the apparatus 1 according to the invention in cross section. As can be seen from the figure, the base 3 is symmetric in cross section about a plane normal to the lower face 5 of the base 3. This design of base 3 is particularly suitable for tidal streams where the fluid can flow over the apparatus 1 in both directions.

The base 3 acts to reduce the depth of the fluid stream 2. In use, as the fluid flows along the fluid bed and reaches the base 3, the upper face 4 of the base 3 adds an upward component to the velocity of the fluid near the bottom of the stream. This fluid interacts with the fluid above the base 3, augmenting the flow and so increasing the speed of the fluid above the base 3 in an accelerated region 16. The foil arms 13 are arranged such that the foils 14 are over the upper face 4 of the base 3 in this accelerated region 16 of increased speed for at least a portion of their range of oscillatory motion. The angle change mechanism arranges the foils 14 such that as the fluid flows over them the foil arms 13 pivot about their connections to the support arms 12. When the foil arms 13 reach an end of their pivot range the angle change mechanism alters the angle of the foils 14 so that the foil arms 13 pivot in the opposite direction.

As shown in FIGS. 1 and 2 the two foils 14 are arranged adjacent to each other so that they both lie in this relatively small accelerated region 16 of increased speed for at least part of the pivoting motion of their associated foil arms 13. In this embodiment the foils 14 lie in a region above the third planar face 9 for a substantial portion of their oscillatory motion.

FIG. 3 shows the apparatus 1 according to the invention in a storage position. In this position the foils 14 are arranged close to the upper face 4 of the base 3. Very close to the upper face 4 the direction of flow of the fluid is substantially parallel to the upper face 4 as shown. The foils 14 are aligned with, and face into, the fluid flow. In this embodiment the foils 14 are aligned with the first and second planar faces 7,8 as shown. Placing the apparatus 1 in this storage position reduces the likelihood of damage to the apparatus 1, particularly the foils 14, if the fluid flow is unusually, fast or turbulent.

It can be necessary to remove the apparatus 1 from the fluid stream, for example for maintenance or to repair damage. This is achieved by emptying some or all of the ballast tanks of the fluid and replacing the fluid typically with air to increase the buoyancy of the base 3. In this embodiment a pump (not shown) on the surface fills the ballast tanks with air. The base 3 then floats up between the columns 10,11 until the base 3 is above the stream 2 as shown in FIG. 4. Typically, the apparatus 1 is arranged in the storage configuration before the lifting begins.

Shown in FIGS. 5(a) to 5(d) are alternative bases 3 of apparatus 1 according to the invention in cross section. FIG. 5(a) shows a base 3 of similar construction to that of FIG. 1. This base 3 however is more suitable for fluid streams which approach the base 3 from one side only. The base 3 is therefore asymmetric about the plane normal to the lower face 5 of the base 3 with one of the first and second planar faces 7,8 making a more acute angle with the lower face 5 than the other. The base 3 of FIG. 5(b) is similar to that of FIG. 5(a) except the third planar face 9 is inclined to the lower face 5. FIG. 5(c) shows a base 3 having an upper face 4 comprising five planar faces. FIG. 5(d) shows a base 3 having a curved upper face 4.

In the embodiment of FIG. 1, each foil 14 is supported by two foil arms 13. In an alternative embodiment each foil 14 is supported by one foil arm 13. In further alternative embodiments a mixture of the two are possible, with larger foils 14 being supported by a plurality of foil arms 13 and smaller foils 14 being supported by a single foil arm 13.

In alternative embodiments of the invention other shapes of foil 14 are possible. Both sides of the foil 14 can be convex. Alternatively one side can be planar and the other convex. As a further alternative one side can be concave and the other convex. In a preferred alternative the foils 14 are bi-directional foils, able to generate lift when fluid flows over the foil 14 from edge to edge in either direction. With a bi-directional foil 14 the angle change means needs only to adjust the angle of the foil 14 slightly to reverse the direction of flow over the foil 14 and hence the direction of the generated thrust.

The embodiment of FIG. 1 comprises foils 14 arranged side by side. The foil arms 13 are arranged to extend away from the foils 14 in substantially opposite directions as shown. When the apparatus 1 comprises a plurality of foils 14 such an arrangement is to be preferred as it allows the foils 14 to be arranged in the relatively small accelerated region where the Venturi effect accelerates the fluid flow. In an alternative embodiment of the invention the apparatus 1 comprises only one foil 14 arranged above the upper face 4 of the base 3 in the accelerated region 16.

In alternative embodiments of the invention the apparatus 1 comprises lifting means (not shown) for lifting the base up the columns 10,11. In one embodiment the lifting means are arranged within the base 3 and typically comprise a gearing mechanism which engages with teeth on the columns 10,11. In an alternative embodiment of the invention the lifting means is arranged above the fluid. The columns 10,11 may for example include gear or chain mechanisms which are driven from the surface by the lifting means to raise the base 3. Optionally, such embodiments include one or more ballast tanks which may be filled with air to reduce the work done by the lifting means.

In a further embodiment of the invention the generator is arranged at the surface. A linkage, for example a hydraulic linkage, a chain or cord extends from the base 3 to the generator for transferring the oscillatory motion of the foil arms 13 to the generator.

In the above embodiments the lower face 5 is planar. Other shapes of lower face 5 are possible depending upon the shape of the fluid bed. The lower face 5 may comprise legs.

The stream can be a flowing portion of a larger body of water. For example, the apparatus 1 can be installed on an ocean bed with a portion of the ocean being a stream flowing over the apparatus 1. The apparatus 1 can be installed in rivers or estuaries or other flowing bodies of water.

1. An apparatus for generating power from a fluid stream flowing along a stream bed, comprising:
a base comprising a lower face for resting on the stream bed;
a foil arm pivotally connected to the base; and,
a foil pivotally connected to the foil arm remote from the base;
the base further comprising an upper face for directing fluid flow towards the foil, so augmenting fluid flow over the foil.

2. An apparatus as claimed in claim 1, wherein at least a portion of the upper face is convex.

3. An apparatus as claimed in claim 2, wherein at least a portion of the convex upper face is curved.

4. An apparatus as claimed in claim 2, wherein the convex upper face comprises a plurality of planar faces, each planar face inclined to an adjacent planar face.

5. An apparatus as claimed in claim 4, wherein the convex upper face comprises first and second planar faces extending from the lower face and inclined thereto and a third planar face extending therebetween.

6. An apparatus as claimed in claim 5, wherein the third planar face is parallel to the lower face.

7. An apparatus as claimed in claim 6, wherein the base is symmetric about a plane normal to the lower face.

8. An apparatus as claimed in claim 7, wherein the base comprises at least one ballast tank.

9. An apparatus as claimed in claim 8, further comprising a pump for emptying and filling the ballast tank, preferably with air, to alter the buoyancy of the apparatus.

10. An apparatus as claimed in claim 9, further comprising at least one column adapted to be connected to the bed of the stream, the base being connected to the column.

11. An apparatus as claimed in claim 10, wherein the base is adapted to be displaced along the column to alter the depth of the base in the stream.

12. An apparatus as claimed in claim 1, further comprising a generator within the base for converting the pivoting motion of the foil arm into electricity.

13. An apparatus as claimed in claim 1, wherein the foil arm is further defined as a plurality of foil arms pivotally connected to the base, each foil arm being pivotally connected to the foil.

14. An apparatus as claimed in claim 1, wherein the foil is further defined as a first foil and a second foil and the foil arm is further defined as a first foil arm and a second foil arm, wherein
the first and second foil arms are each pivotally connected to the base and extend towards each other,
each foil arm having one of the foils pivotally connected thereto; and
the foils being arranged side by side such that the upper face directs the fluid over both foils.

15. An apparatus as claimed in claim 14, wherein the foil arms extend away from the foils in substantially opposite directions

16. (canceled)

17. An apparatus as claimed in claim 1, wherein the base is symmetric about a plane normal to the lower face.

18. An apparatus as claimed in claim 1, wherein the base comprises at least one ballast tank.

19. An apparatus as claimed in claim 18, further comprising a pump for emptying and filling the ballast tank, preferably with air, to alter the buoyancy of the apparatus.

20. An apparatus as claimed in claim 1, further comprising at least one column adapted to be connected to the bed of the stream, the base being connected to the column.

21. An apparatus as claimed in claim 20, wherein the base is adapted to be displaced along the column to alter the depth of the base in the stream.
